(19) United States
(12) Patent Application Publication
(10) Pub. No.: US 2025/0118200 A1
(43) Pub. Date: Apr. 10, 2025

(54) TRAFFIC CONTROL SYSTEM

(71) Applicant: FLEX TRAFFIC SYSTEMS, LLC, Mesa, CO (US)

(72) Inventor: Jennifer Ealey, Collbran, CO (US)

(21) Appl. No.: 18/982,544

(22) Filed: Dec. 16, 2024

Related U.S. Application Data
(63) Continuation-in-part of application No. 18/057,275, filed on Nov. 21, 2022.
(60) Provisional application No. 63/264,455, filed on Nov. 23, 2021.

(51) Int. Cl. G08G 1/095; G08C 17/02

(52) U.S. Cl. CPC G08G 1/095; G08C 17/02

(57) ABSTRACT

A traffic control system is disclosed as it may include a plurality of separate signal mats for placement on a surface on or near a road or pathway. An example traffic control system includes a lighting circuit having a plurality of lights mounted to each of the signal mats. The example traffic control system also includes a control circuit mounted to each of the signal mats. The example traffic control system also includes a communications device configured for remote communications with the communications device of at least one other of the signal mats. The example traffic control system also includes a programming module to execute a coordinating program to operate the lighting circuit based at least in part on the remote communications with the at least one other signal mat to alert travelers on or approaching the road or pathway to a traffic control plan.

### CROSS-REFERENCE TO RELATED APPLICATIONS

This application is a continuation in part (CIP) of U.S. patent application Ser. No. 18/057,275 filed Nov. 21, 2022 for “Lighted Traffic Control Device” of Jennifer Ealey, which claims the priority filing benefit of U.S. Provisional Patent Application No. 63/264,455 filed Nov. 23, 2021 for “Lighted Traffic Control Device” of Jennifer Ealey, each hereby incorporated by reference in its entirety as though fully set forth herein.

### BACKGROUND

Work zones on highways and roadways are extremely dangerous for the work crews. Even with extensive signage and road barriers, workers are killed in work zones every year. Often, drivers will say that road signage “disappears” (or blends into the background) because of the numerous clutter of signs (both road signs and commercial signs) already seen daily by motorists alongside the roadway. As such, many drivers do not even notice work zone signage on the side of the road when entering a work zone.

### BRIEF DESCRIPTION OF THE DRAWINGS

FIG. 1 illustrates an implementation of example lighted traffic control devices configured to provide drivers with warnings in a work zone that is partially closed for road repair.

FIG. 2 is a perspective view of an example lighted traffic control device.

FIG. 3 is a side cross-sectional view of the example lighted traffic control device shown in FIG. 2.

FIG. 4 is a top plan view of the example lighted traffic control device shown in FIG. 2 having an X-shape pattern.

FIG. 5 is a top plan view of another example lighted traffic control device having a circle shape pattern.

FIG. 6 is a top plan view of another example lighted traffic control device having an arrow shape pattern.

FIG. 7 is a top plan view of another example lighted traffic control device having a configurable pattern.

FIG. 8 shows another example traffic control device which may be implemented in a system of traffic control devices.

FIG. 9 is a side view of the example traffic control device shown in FIG. 8.

FIG. 10 are top views of example traffic control devices which may be implemented in a system of traffic control devices.

FIG. 11 shows another example traffic control device which may be implemented in a system of traffic control devices.

FIG. 12 illustrates an example deployment of traffic control devices configured for an emergency response situation.

FIGS. 13-15 illustrate examples of deployment of traffic control devices configured for various types of work zone.

### DETAILED DESCRIPTION

A lighted traffic control device is disclosed which may be utilized in work zones as a temporary traffic control device for use on roadways. An example lighted traffic control device may be implemented as a signal mat (or simply a “mat”) configured for placement on a road surface to bring attention to approaching lane closures and other work zone strategies with lighting. Multiple signal mats may be provided in communication individually or in combination with other signal mats (e.g., as a network) that can be set up, configured, monitored, and controlled remotely (e.g., via a mobile device app) to provide a coordinated traffic management strategy for vehicles, trucks, pedestrians, cyclists, etc. for work zones, roadways, pathways, special events, etc.

In an example, the lighted traffic control device includes an independent power source integral with the mat. The example lighted traffic control device also includes an LED lighting circuit having a plurality of LED lights inset into the mat in a configuration corresponding to a road sign. The road sign may be permanently embedded in the mat, or configurable, e.g., by turning LED lights on/off according to a pattern. The example lighted traffic control device also includes a control circuit integral with the mat to operate the LED lighting circuit according to a road or lane closure plan.

The example lighted traffic control device may include universally known traffic control colors such as those used by nearly every country throughout the world. This makes the lighted traffic control device recognizable by nearly all drivers globally. The example lighted traffic control device can help to decrease the number of accidents and fatalities due to distracted or drowsy drivers, by “grabbing” the drivers attention where the driver is most likely to be looking-at the road ahead.

A traffic control system is also disclosed as it may include multiple lighted traffic control devices or signal mats. The signal mats may be deployed on a surface on or near a road or pathway for various traffic control situations. An example system includes a plurality of signal mats each having a lighting circuit with a plurality of lights that can be configured, actuated/deactivated in coordination with one another according to a traffic control plan for a traffic control situation. The signal mat can be used for permanent or temporary applications.

In an example, the signal mats can be driven on or over, and provide a traffic control device for the use on roadways to better bring attention to approaching lane closures, lane shifts, detours, and other work zone and traffic control strategies. The signal mats are designed to operate with universally known colors that are used for traffic control in most every country, making the signals recognizable by drivers globally. Use of the signal mats can decrease the number of accidents and fatalities due to distracted or drowsy drivers by “grabbing” the attention of drivers. That is, the output from the signal mats does not “disappear” into the cluttered signage already being seen by motorists alongside the roadway. For example, some extensive work zone setups have a lot of construction orange, which can be overwhelming to motorists, blending everything together and “fading” into the background. The use of the signal mats disclosed herein helps the signage stand out and be easily recognized.

In an example, the signal mats have a no-slip design for engaging with the roadway or other surface. The signal mats may, in addition or instead of, have the ability to be temporarily adhered to the surface (e.g., the pavement) by the use of mechanical fasteners and/or adhesive pads.

The flexibility of the mat helps to ensure functionality in a variety of different applications and roadway surfaces, including those that vary in pitch, where rigid materials would otherwise fail to conform to the surface that the signal mats are placed on.

It is noted that motorists are statistically more likely to straddle an object in the roadway rather than run it over. With that in mind, the signal mat can have a width of about 3 to 4 feet to be readily straddled by vehicles and trucks. Of course, the signal mats do not need to be any particular size, and can be larger or smaller based on application. In addition, the signal mat can be of sturdy construction to be driven over by vehicles and trucks. Embedding the components below the top surface of the signal mat and/or providing protective covers can also help reduce or eliminate damage to the components (e.g., solar panels, batteries, circuitry, sensors, etc.)

In an example, the signal mat includes inlaid solar panels, re-chargeable battery pack(s), and LED lights and/or light panels. Example light patterns include a red X, green O, amber O, and sequencing (e.g., “moving”) yellow arrow(s). The lights can provide steady lighted output, on/off or blinking/flashing, and/or run sequencing patterns. The LED lights can be housed in a waterproof enclosure for all weather applications.

A control circuit is mounted to each of the signal mats. A communications device is configured for remote communications with the communications device of at least one other signal mat. A programming module executes a coordinating program to operate the lighting circuit based at least in part on the remote communications with at least one other signal mat. The coordinating program may include turning one or more lights on and one or more lights off, sequencing, blinking or flashing, etc., all in a coordinated pattern across multiple signal mats in the system to alert travelers on or approaching the road or pathway to a traffic control plan.

During operation, the communications device of the control circuit receives a control signal from a remote device. The remote device can be a sensor device and/or another computing device such as a program application executing on a server computer, personal computer, mobile device (e.g., mobile phone, tablet, dedicated device), etc. The control signal corresponds to the traffic control plan to be implemented. For example, the control circuit can communicate with the lighting circuit to activate/deactivate the lights based at least in part on the traffic control plan specified by the control signal. Control signals can specify lighting output (e.g., on/off status, brightness, blinking, color, pattern coordination, etc.) for the control circuit to communicate to the lighting circuit. The lighting circuit controls the LED lights accordingly.

In an example, the traffic control plan can be generated at least in part based on artificial intelligence (AI) and/or a machine learning program. For example, the AI and/or machine learning program may generate a traffic control plan to include lights of the lighting circuit on one of the signal mats outputting a light pattern coordinated with the lighting circuit of at least one other of the signal mats based on user input, signal input, prior use scenarios, regulations, and/or any other information provided to the model or algorithm.

In an example, the lights of the lighting circuit can be provided as a panel to output a light pattern selected from a plurality of different light patterns. For example, a panel of more than one light can be provided to light up in different shapes (e.g., circle, X, square) and/or patterns (e.g., a moving arrow, blinking lights that mimic law enforcement blue and/or red flashing lights) on the same signal mat.

In an example, the control circuit receives a remote control signal. That is, the remote control signal may be delivered from a device not attached to or hardwired to the signal mat. The control circuit receives the remote control signal to configure output of the lighting circuit. The control circuit may receive one-way communication from the remote device and/or may interact with the remote device via bi-directional communication (e.g., a feedback loop).

In an example, the control circuit is operable to activate/deactivate lights of the lighting circuit and to control blinking/solid output, color output, and display pattern output of the lights of the lighting circuit. The output color of the lights can be at least one of red, green, and/or warning yellow, or emergency colors such blue, white, and/or red. The output color of the lights can be controlled to switch between different colors.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

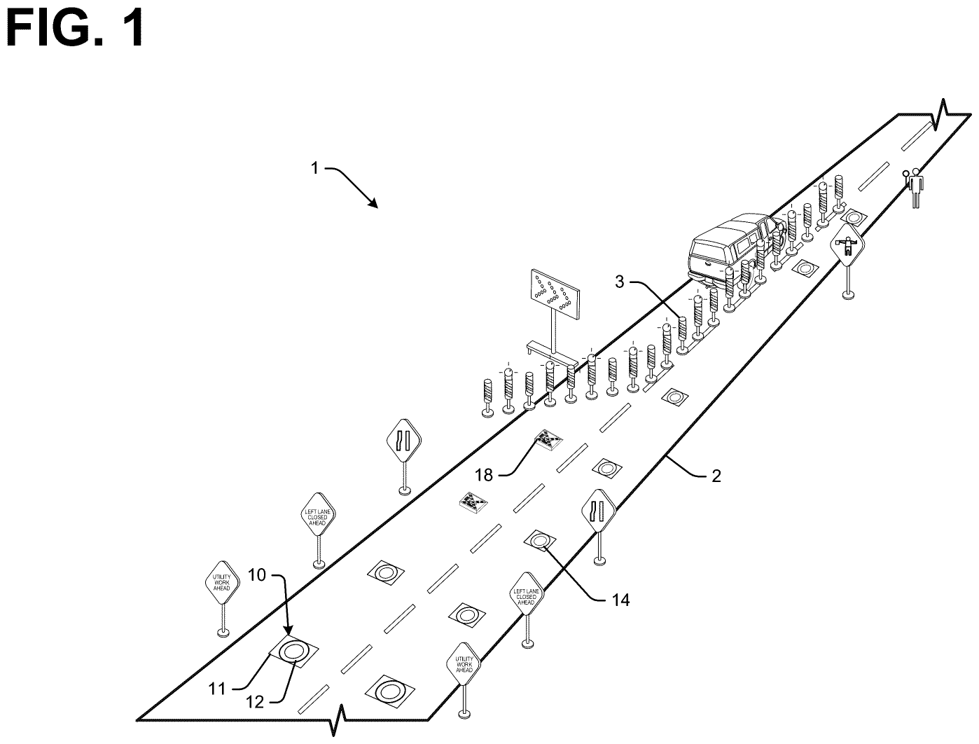

FIG. 1 illustrates an implementation of example lighted traffic control devices configured to provide drivers with warnings in a work zone 1 that is partially closed for road repair.

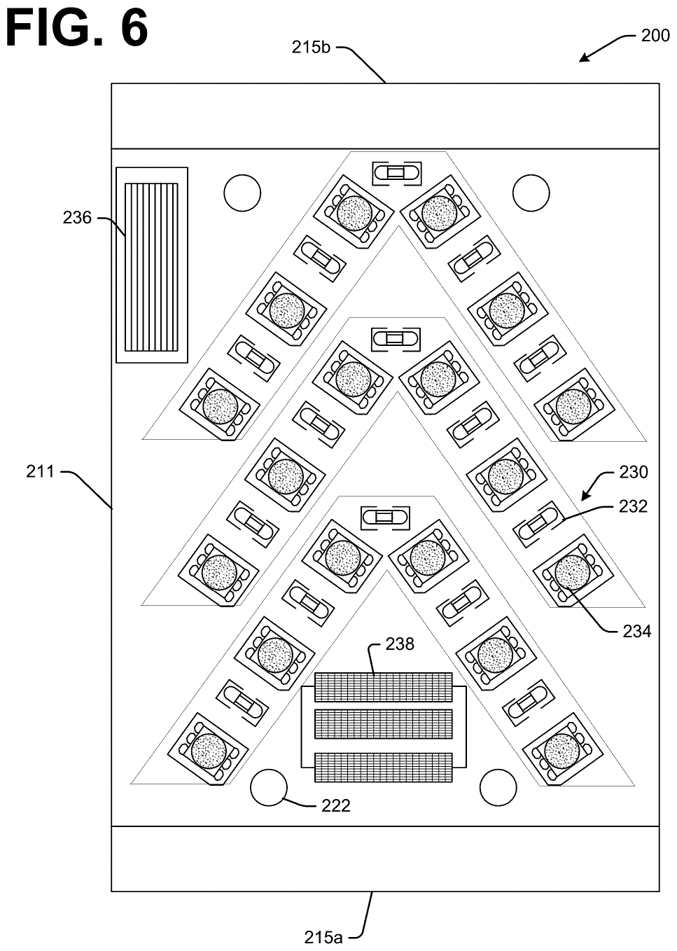

An example lighted traffic control device 10 includes a mat 11 which can be driven over and has inlaid solar panels, a chargeable battery pack, and a designated lighting pattern 12. Example light patterns 12 may be generated by light emitting diodes (LEDs) and may include by way of example, a green “O” 14 to indicate a travel lane, a yellow “O” 16 to indicate caution (the lane is ending), and a red “X” 18 to indicate a lane closure. Other colors and/or light patterns 12 may also be provided, such as but not limited to one or more arrows (see, e.g., FIG. 6).

The lighted traffic control device 10 is configured for positioning on a road 2 to bring attention to approaching lane closures 3 and other work zone strategies (e.g., rerouting traffic, slowing traffic). It is noted that motorists are statistically more likely to straddle an object in the roadway rather than run it over. With that in mind the example lighted traffic control device 10 may be designed for widths from about 3-4 feet. In an example, the mat is about 3 inches tall and about 3 feet wide by 3 feet long. However, larger and smaller configurations are also contemplated for other application needs.

In an example, the lighted traffic control device 10 is capable of withstanding force and weight of trucks, vehicles, and equipment traveling over the roadway. For example, the mat 11 may be made of rubber and/or other hard material, and the LED lights, solar panels, and circuitry may be embedded in the mat. In an example, the LED lights, solar panels, and circuitry are waterproof for all weather applications. The example lighted traffic control device 10 may also have a no-slip design to reduce movement on the roadway.

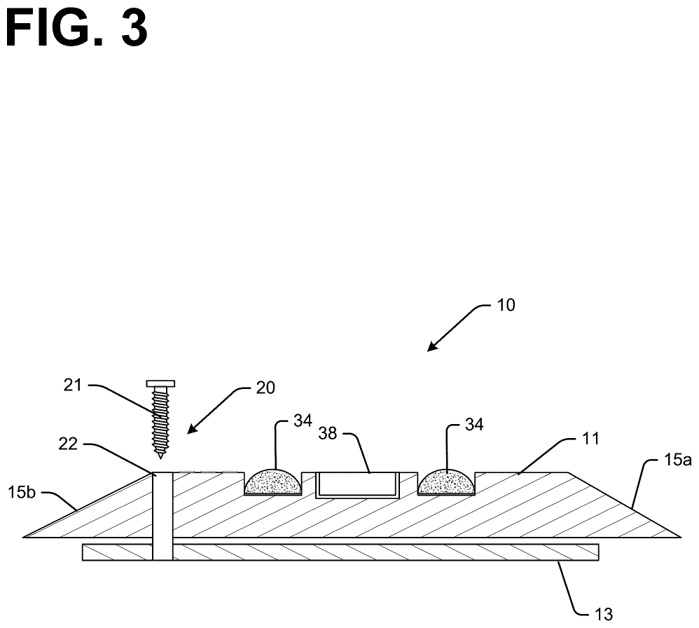

The traffic control device 10 may include a heavy rubber mat suitable for driving over by vehicular traffic or a mat that is not readily picked up by wind or airflow generated by passing vehicles. The example lighted traffic control device may be temporarily adhered to pavement by the use of mechanical fasteners or adhesive or other anti-slip (e.g., friction) pads (see, e.g., pad 13 in FIG. 3).

In an example, traffic control device 10 may include at least one mat attachment to attach the mat 11 on or near the road surface 2. For example, the mat attachment 20 shown in FIG. 3 includes one or more spike 21 or other fasteners which may be provided through a corresponding opening 22 formed through the mat 11 and driven into the ground or roadway to secure the mat on or near the road surface 2. However, other mat attachments may also be provided instead of or in addition to the mat attachment 20, such as an adhesive, weight, chain, etc.

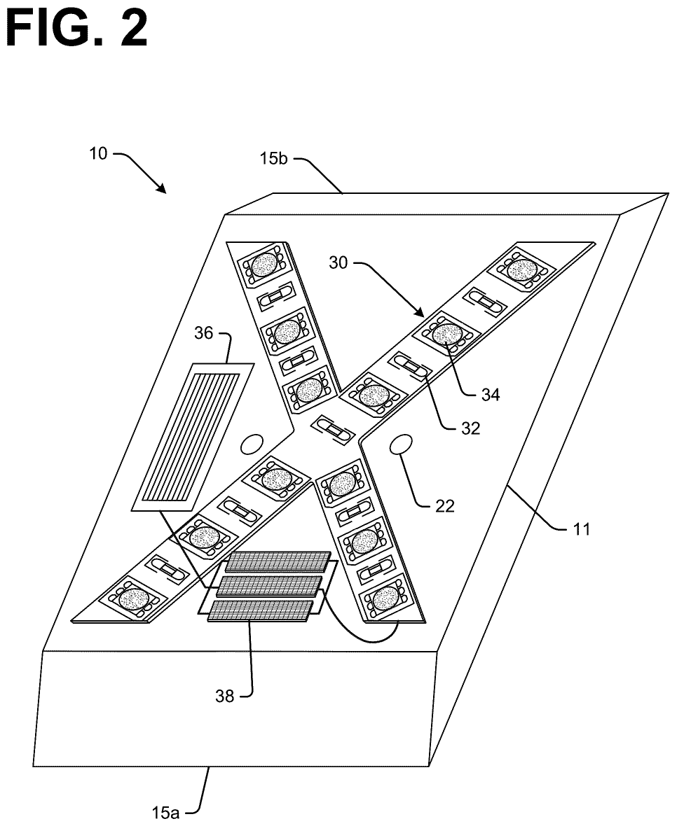

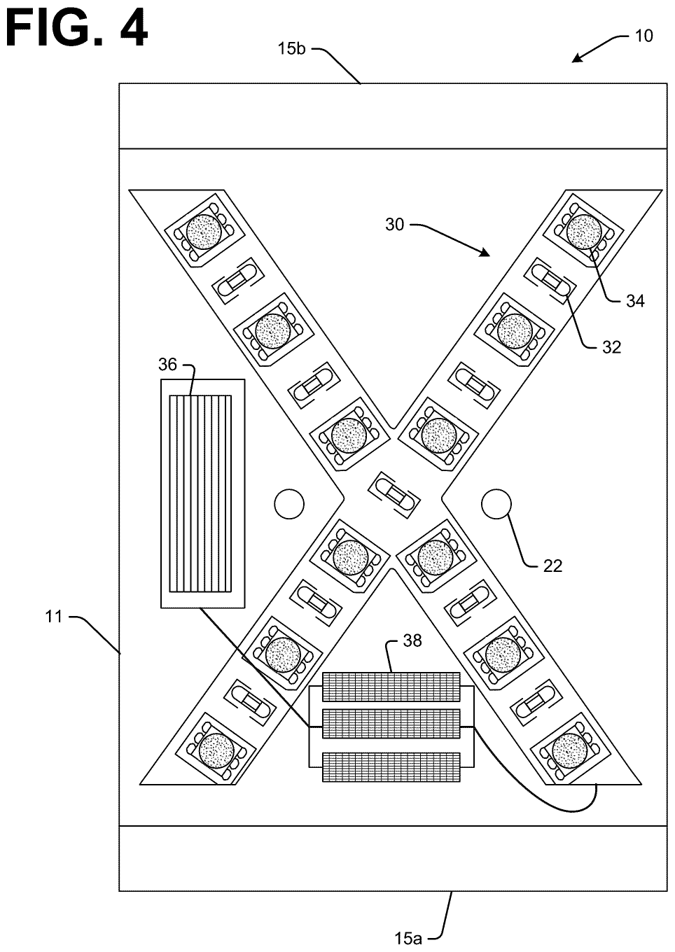

FIG. 2 is a perspective view of an example lighted traffic control device 10. The mat 11 is shown as it may have angled entry and exit planes 15a, 15b in the event a vehicle tire travels over the mat 11. FIG. 3 is a side cross-sectional view of the example lighted traffic control device shown in FIG. 2. FIG. 4 is a top plan view of the example lighted traffic control device shown in FIG. 2 having an X-shape lighting pattern 30. The example lighted traffic control device 10 includes a mat 11 configured for placement on a road surface, and LED lights. The LED lights may be embedded into the mat (see, e.g., FIG. 3).

In an example, an LED lighting circuit 32 includes a plurality of LED lights 34. The LED lights may be provided on an LED strip or ribbon. In an example, the LED lights 34 are inset into the mat 11 to reduce or prevent damage to the LED lights 34. The LED lights 34 may be provided in a configuration or light pattern corresponding to a road sign. In this example, the LED lights 34 form an X-shape pattern 30.

The LED lights 34 are operated by a control circuit 36 integral with the mat 11. The LED lights 34 may be operated according to a road or lane closure plan. The LED lights 34 may be operated to generate any suitable output (e.g., color, brightness, and even the pattern itself) to bring attention to approaching lane closures and other work zone strategies.

In an example, the control circuit 36 may be pre-programmed (e.g., from the manufacturer) to generate a desired lighting output. In another example, the control circuit 36 is programmable. In another example, the control circuit 36 may be programmed on site, e.g., by an operator configuring the control circuit 36 on-board the device 10. In another example, the control circuit 36 receives a remote control signal. For example, the control circuit 36 may receive a remote control signal to configure and/or update output of the LED lights 34. This helps keep the user from having to go out onto the roadway to activate/deactivate and/or change output of the LED lights 34.

In an example, the LED lights 34 may be colored and/or the light output color may be changed. For example, the output color of the LED lights 34 may be at least one of “stop” red, “go” or “proceed” green, and a “warning” yellow, e.g., as may be defined by traffic safety standards. The output color of the LED lights 34 may be controllable (e.g., by the control circuit 36) to switch between the different colors. By way of illustration, the color output by the LED lights 34 may be changed from yellow to red or from red to green, depending on the needs at the worksite. Of course, other colors may also be utilized as needed by the end-user and/or application (e.g., for parade routes, for processions, etc.).

The control circuit 36 and LED lights 34 are powered by an independent (i.e., receiving no outside power) on-board power source 38 provided integral with the mat 11. In an example, the power source 38 is at least one solar panel embedded in the mat 11. The power source 38 may also include at least one battery. For example, the power source 38 includes one or more rechargeable batteries and at least one solar panel to recharge the battery. In another example, electrical power may be provided by a separate power source (e.g., a separate mat having one or more power sources to provide electrical power to one or more adjacent mats).

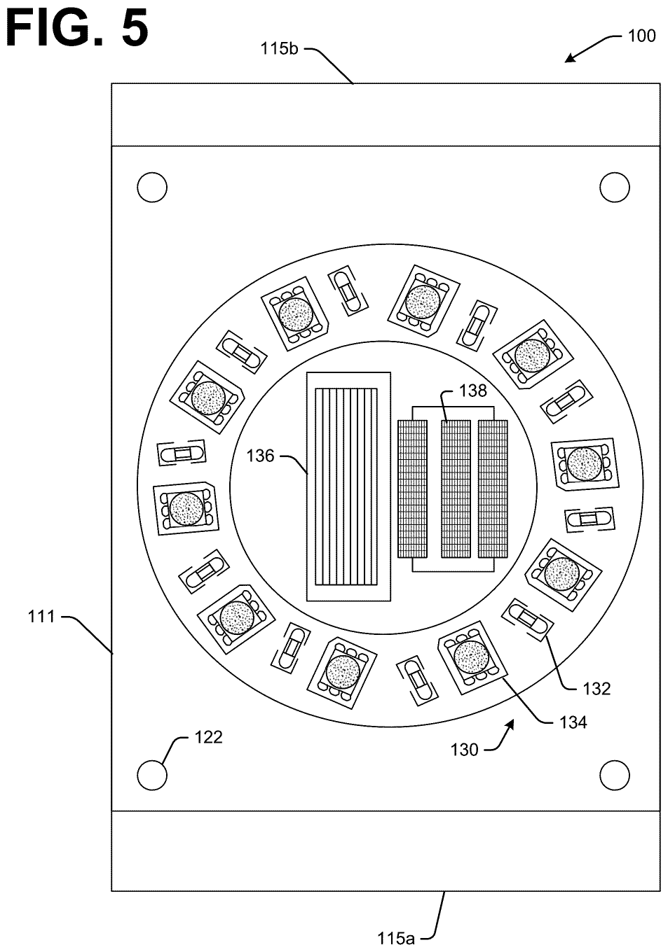

FIG. 5 is a top plan view of another example lighted traffic control device 100 having a circle or “O” shape pattern 130. It is noted that 100-series reference numbers are used to describe corresponding parts already described above and may not be described again with reference to FIG. 5 where that description would otherwise be the same as previously described.

In an example, an LED lighting circuit 132 includes a plurality of LED lights 134. The LED lights may be provided on an LED strip or ribbon. In an example, the LED lights 134 are inset into the mat 111 to reduce or prevent damage to the LED lights 134. The LED lights 134 may be provided in a configuration or light pattern corresponding to a road sign. In this example, the LED lights 134 form an “O” shape pattern 130.

The LED lights 134 are operated by a control circuit 136 integral with the mat 111. The LED lights 134 may be operated according to a road or lane closure plan. The LED lights 134 may be operated to generate any suitable output (e.g., color, brightness, and even the pattern itself) to bring attention to approaching lane closures and other work zone strategies.

FIG. 6 is a top plan view of another example lighted traffic control device 200 having an arrow shape pattern 230. It is noted that 200-series reference numbers are used to describe corresponding parts already described above and may not be described again with reference to FIG. 6 where that description would otherwise be the same as previously described.

In an example, an LED lighting circuit 232 includes a plurality of LED lights 234. The LED lights may be provided on an LED strip or ribbon. In an example, the LED lights 234 are inset into the mat 211 to reduce or prevent damage to the LED lights 234. The LED lights 234 may be provided in a configuration or light pattern corresponding to a road sign. In this example, the LED lights 234 form an arrow shape pattern 230.

The LED lights 234 are operated by a control circuit 236 integral with the mat 211. The LED lights 234 may be operated according to a road or lane closure plan. The LED lights 234 may be operated to generate any suitable output (e.g., color, brightness, and even the pattern itself) to bring attention to approaching lane closures and other work zone strategies. For example, the arrows may be lit and dimmed or turned off sequentially to indicate forward motion. Or for example, 1 or more of the arrows may be lit while one or more of the other arrows are not lit. Different arrows may be lit with different colors and/or brightness.

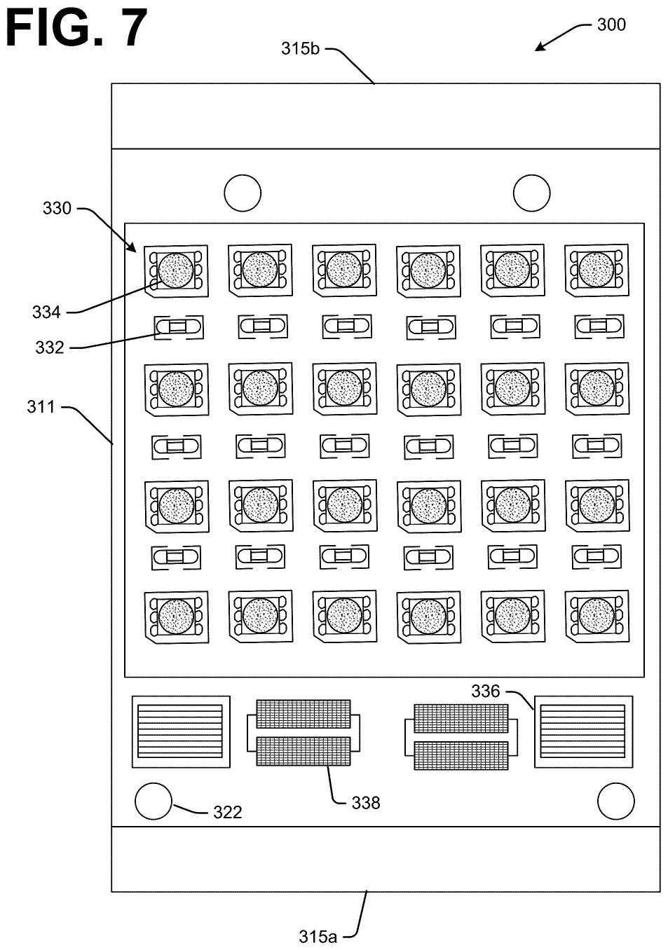

FIG. 7 is a top plan view of another example lighted traffic control device 300 having a configurable pattern 330. That is, the LED lights 334 are provided as a panel that can be activated to output a plurality of different shape signs. It is noted that 300-series reference numbers are used to describe corresponding parts already described above and may not be described again with reference to FIG. 7 where that description would otherwise be the same as previously described.

In an example, an LED lighting circuit 332 includes a plurality of LED lights 334. The LED lights may be provided as a panel and/or as parallel LED strips or ribbons arranged to configure multiple different patterns of light output corresponding to more than one road sign. In an example, the LED lights 334 are inset into the mat 311 to reduce or prevent damage to the LED lights 334.

The LED lights 334 are operated by a control circuit 336 integral with the mat 311. The LED lights 334 may be operated according to a road or lane closure plan. The LED lights 334 may be operated to generate any suitable output (e.g., color, brightness, and even the pattern itself) to bring attention to approaching lane closures and other work zone strategies. For example, the control circuit 336 may be operable to activate/deactivate the LED lights and to control blinking/solid output, color output, and display different patterns (e.g., the X, O, the arrows described above, and/or other patterns) to be output by the LED lights 334.

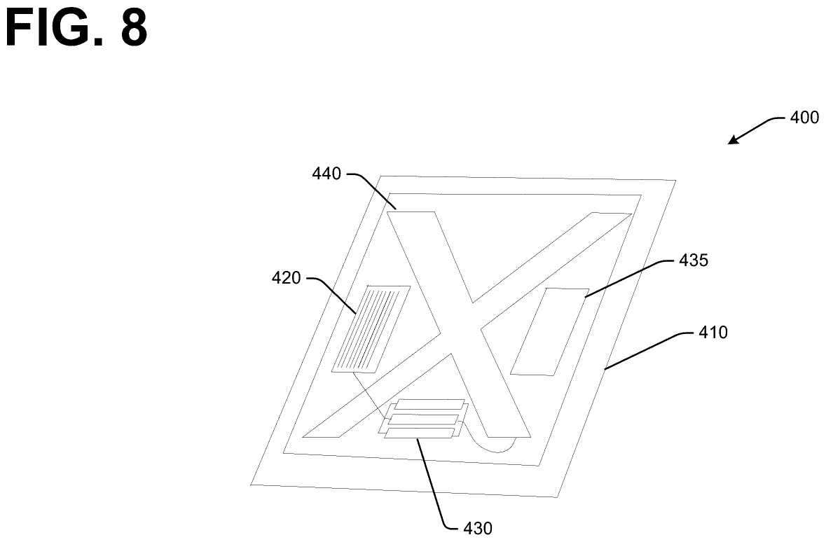

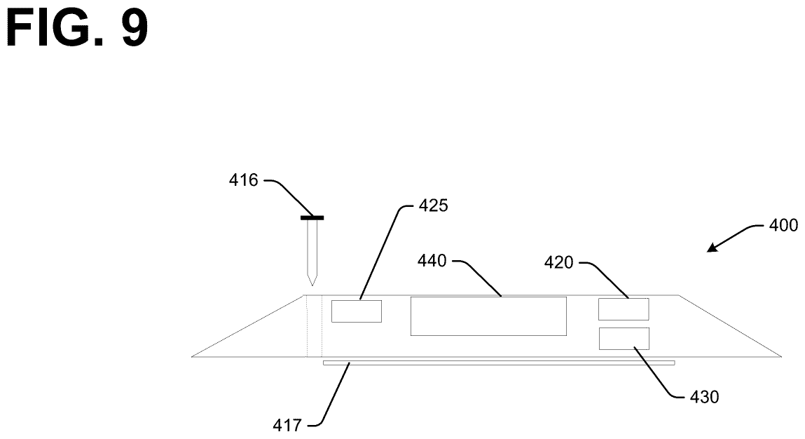

FIG. 8 shows another example traffic control device 400 which may be implemented in a system of traffic control devices. The traffic control system may include a plurality of separate signal mats for placement on a surface on or near a road or pathway. In an example, at least one of the separate signal mats is communicably coupled to at least one other signal mat, such that the plurality of signal mats cooperate with one or more other signal mats to implement a traffic control plan. FIG. 9 is a side view of the example traffic control device 400 shown in FIG. 8. The traffic control device 400 is shown as it may be configured as a signal mat 410. However, signs may also be incorporated into the traffic control system. Indeed, the traffic control system may also be communicatively coupled with other devices (e.g., mobile phones, vehicle head units, and/or other user interfaces).

In an example, the signal mat 410 may be about 3 inches tall and about 3 feet wide by 3 feet long. The signal mat 410 may be made of a durable material, to withstand the weight and repeated vehicular and truck traffic. It is noted that while described herein as it may be used for vehicular and truck traffic, the signal mat 410 may also be implemented to accommodate different types of traffic, such as, but not limited to, pedestrian and/or cycling traffic on walking and bicycle paths.

In an example, the signal mat 410 may be made of a pliable material, to substantially conform to a variety of different types of terrain, including uneven surfaces, slopes, curvatures, and other deployment surfaces, so that the signal mat 410 lays substantially flat once deployed on the surface. The signal mat 410 may include one or more mat attachments 415 to attach the signal mat 410 on or near the surface of the road or pathway. Suitable mat attachments 415 may include spikes 416, adhesives 417, etc.

The signal mat 410 may be engineered to support extremely high loads, often exceeding several tons. This makes them suitable for use with heavy construction machinery, transport vehicles, and even military vehicles. The signal mat 410 may be constructed to withstand harsh conditions, including rough terrain, mud, snow/ice, and wet environments. The signal mat 410 may be designed to be durable and long-lasting, reducing the need for frequent replacements.

The signal mat 410 may include non-slip surface(s) that provide traction even in slippery conditions. The surface of the signal mat 410 may feature ribs or ridges that provide additional traction and stability. This design helps prevent vehicles from slipping and ensures a secure footing.

The signal mat 410 may be constructed of rubber or other suitable polymer. Rubber is desirable due to its flexibility, durability, and non-slip properties. Rubber mats can absorb shock and provide a stable surface for vehicles. High-Density Polyethylene (HDPE) is a lightweight yet strong plastic material that is resistant to wear and tear. The signal mat 410 may also be made from composite materials that combine the strength of plastics and metals (e.g., aluminum frame) to offer superior durability and to withstand extreme loads.

The signal mat 410 may be provided together with other signal mats as a system to create temporary traffic patterns, including roadways for general traffic and access paths for construction vehicles. In an example, the signal mat 410 may include interlocking panels that can be easily connected to one another to form a stable surface. This modular design allows for flexibility in size and shape of the individual signal mat 410, making it easy to cover large areas.

The signal mat 410 may have contoured edges (e.g., ramped edges shown FIGS. 8 and 9). The edges of the signal mat 410 may be reinforced to prevent tearing and damage. This reinforcement ensures that the mats remain intact even under heavy loads and rough handling.

The signal mat 410 may be designed for quick and easy installation and removal. This allows for efficient setup and dismantling, which is essential in dynamic environments such as emergency responder situations on the roadside, construction zones, special events, etc. By way of illustration, for military operations, the signal mats 410 can be used to create temporary roads and landing strips. The signal mats 410 can provide a reliable surface for military vehicles and equipment, even in challenging terrain. In work zones, the signal mats 410 can be deployed in any of a variety of different configurations to accommodate changing needs of the construction crews and equipment. In emergency situations, the signal mats 410 can be quickly deployed to create access routes for rescue vehicles. The system can be deployed to help ensure that emergency responders can reach the affected area without interference from traffic near the site.

The signal mats 410 may include a number of embedded components. It is noted that the term “embedded” as used herein to describe the various components of the signal mat 410, means built into the mat in such a manner so as to remain below an outer surface of the mat to reduce wear and tear on these components from traffic driving over the mat.

In an example, a solar panel 420 may be provided in the signal mat 410 to provide on-demand power and/or power for an energy storage device 425 (also embedded in the signal mat 410) such as a battery.

Circuitry may also be embedded in the signal mat 410. Circuity may include, but is not limited to, a lighting circuit 430 for a plurality of lights (e.g., LED light pattern 440) embedded in the signal mat 410. The LED light pattern 440 may be any suitable shape and may be predetermined (e.g., the X shown in FIG. 8), or changeable (e.g., a panel that can be lighted in the shape of an X, an O, a series of arrows, etc.). The light pattern can be solid, blinking, or made to appear to move. For example, the light circuit may light a first arrow, then a second arrow, and a third arrow, etc., in sequence so that it appears to move. The lighting circuit 430 may be combined with the lights 440 and/or provided separately (e.g., as part of the circuitry designated at 430). The lights may include a diffuser panel and/or protective cover.

The circuitry may also include a control circuit 435 mounted to each of the signal mats 410. The control circuit 435 may include a processor (e.g., a microprocessor) at least sufficient to manage a communications connection via a communications device (e.g., BLUETOOTH™, WiFi, mobile 4G or 5G data, etc.) configured for remote communications with the communications device of at least one other of the signal mats.

The circuitry may also include a programming module (e.g., the circuitry of the control circuit 435), such as a microprocessor configured to execute a coordinating program to operate the lighting circuit based at least in part on the remote communications with the at least one other signal mat to alert travelers on or approaching the road or pathway to a traffic control plan.

In an example, the communications device of the control circuit 435 receives a control signal from a remote device. The remote device can be a sensor device, and/or a computing device, such as a program application (mobile phone app) executing on a mobile device.

The control circuit 435 includes a communication device, such as a microcontroller or a wireless communication module, which acts as the interface between the system and external devices. The remote device (e.g., a central control system or another remote controller) sends a control signal wirelessly, typically using protocols like Wi-Fi, Bluetooth, or cellular networks. Commands may include, but are not limited to, turning a device on/off, adjusting lighting settings, or initiating other specific lighting actions.

The control circuit 435 communication device has a wireless receiver (e.g., a Wi-Fi or Bluetooth module) that receives the incoming control signal. This receiver decodes the signal and sends it to the microcontroller for processing. The microcontroller within the control circuit 435 processes the received signal, interprets the command, and executes the necessary actions. For example, if the command is to activate a light or trigger an alarm, the microcontroller sends the appropriate signals to the relevant components.

Various sensors (e.g., temperature, proximity, infrared) can be connected to the control circuit 435 (hardwired and/or via wireless connections). These sensors can monitor environmental conditions and collect other data. The sensor data is transmitted to the microcontroller within the control circuit 435. The microcontroller processes this data to determine the current state or to detect specific events (e.g., an object approaching the signal mat). Based on the sensor input, the microcontroller can autonomously trigger actions and/or send status updates. For example, if a proximity sensor detects an intrusion by a stray vehicle, it can activate an alarm or send a notification to a remote monitoring system to warn the workers or emergency responders to get out of the way of the stray vehicle.

Users can interact with the control system through a user interface such as a mobile app. The user interface enables users to send commands and receive status updates. The app communicates with the control circuit 435. When a user sends a command through the app (e.g., to change a setting or activate/deactivate a device), the app sends this command wirelessly to the communication device within the control circuit 435. The wireless receiver of the communication device receives the command from the app. The microcontroller then processes this command and executes the necessary actions, such as, adjusting lighting settings, turning the lights on or off, or performing other specific tasks.

In an example, the system seamlessly integrates signals from remote devices, sensor inputs, and mobile app commands. The microcontroller coordinates these inputs to ensure smooth and efficient operation. The control circuit 435 can also include a feedback mechanism. After executing a command, it sends a confirmation or status update back to the mobile app or remote device, informing the user of the action taken and the current state of the system.

In an example, the communication device within the control circuit 435 receives and processes control signals from remote devices and mobile apps, as well as sensor inputs to aid in executing a traffic control plan. The circuitry of the traffic control system helps ensure efficient coordination and execution of commands, providing real-time feedback to users responsible for implementing the traffic control plan. This setup allows for flexible, remote control of the system, enhancing its functionality and user experience.

By way of illustration, the control signal(s) communicated to the signal mat(s) and/or between signal mats correspond to the traffic control plan. The control circuit 435 communicates with the lighting circuit to activate/deactivate the lights based at least in part on the traffic control plan specified by the control signal. For example, the control signal specifies lighting output (individual lights or groups of lights to activate/deactivate, brightness, color, duration, steady/blink, etc.) for the control circuit 435 to communicate to the lighting circuit.

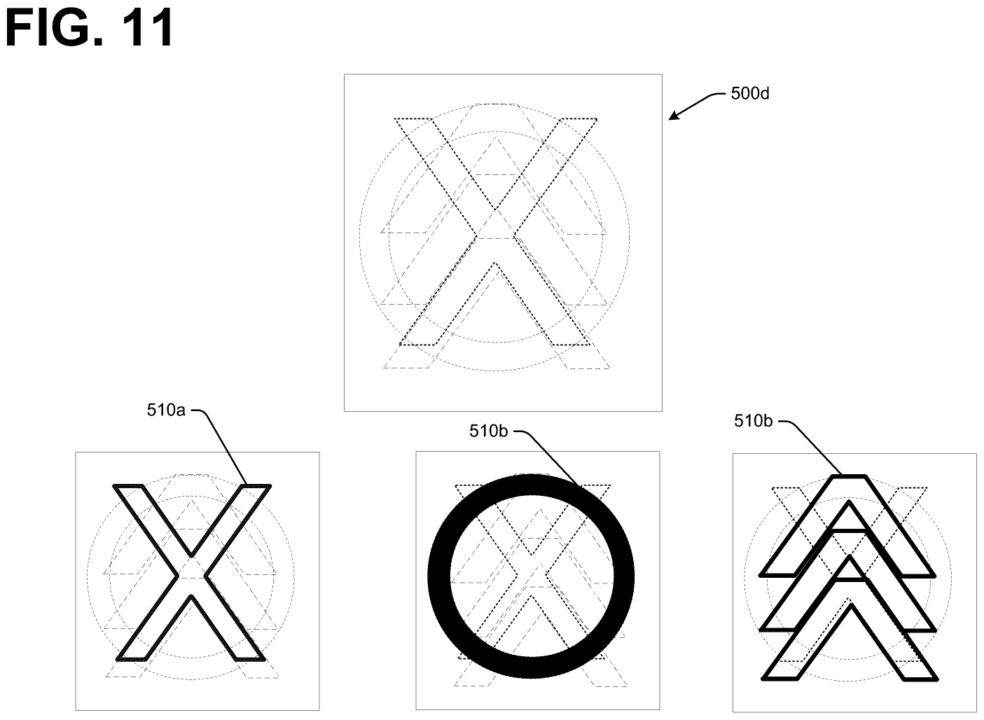

In an example, the lights of the lighting circuit on one of the signal mats output a light pattern that coordinates with the light pattern of one or more other signal mats. The lights of the lighting circuit can be provided as a panel or group of lights to output a light pattern selected from a plurality of different light patterns. An example of a panel or group of lights that can output more than one pattern is shown and discussed below with reference to FIG. 11.

In an example, the control circuit 435 receives a remote control signal during operation, e.g., to configure output of the lighting circuit. The control circuit 435 is operable to activate/deactivate lights of the lighting circuit and to control blinking/solid output, color output, display pattern, and other output parameters of the lights of the lighting circuit. For example, the output color of the lights may be one of red, green, and/or warning yellow. The output color of the lights can also be controlled to switch between the different colors (similar to a traffic signal or “stop” light).

In an example, the traffic control plan is generated at least in part based on artificial intelligence (AI) and/or at least in part based on a machine learning program or algorithm. Traffic control plans are detailed instructions or “blueprints” that outline how traffic is to be managed, e.g., within a work zone or during an emergency responder situation. Traffic control plans may include the signal mat(s) disclosed herein, and optionally additional other traffic control devices such as, but not limited to signs, barricades, cones, and temporary traffic signals. The signal mat(s) and optional other devices help guide and inform road users about the presence of a work zone or emergency situation, or other traffic situation (vehicle, truck, and/or pedestrian, and even aircraft). The traffic control plan aims to minimize congestion, prevent accidents, and ensure the safety of workers, pedestrians, motorists, and others that may be involved.

Artificial intelligence (AI) and machine learning algorithms can significantly enhance the development and implementation of the traffic control plans disclosed herein for implementing the signal mats 410 in work zones and emergency responders at the scene of a traffic accident. An AI-driven system can analyze real-time traffic data from various sensors, cameras, and GPS devices to detect accidents and predict traffic flow patterns. Upon detecting an incident, AI can generate an optimized traffic control plan that includes the use of signal mats 410 for the dynamic rerouting of vehicles, deploying the signal mats 410 in a manner to warn and guide motorists, and adjusting lighting patterns, timing, etc. of the signal mats 410.

In addition, utilizing Artificial intelligence (AI) and machine learning algorithms can continuously improve traffic management strategies by deploying the signal mats 410 based on historical data and even in real time based on current and evolving traffic patterns. As such, Artificial intelligence (AI) and machine learning algorithms can be implemented as part of the system described herein to help ensure the signal mats 410 are implemented in a manner to provide safer and more efficient management of both routine traffic routes (e.g., for sporting and special events), work zones, and emergency situations. The integration of Artificial intelligence (AI) and machine learning algorithms with the traffic control system disclosed herein help minimize congestion, enhance safety for both workers and drivers, and ensure that emergency personnel can respond promptly and effectively.

Traffic control plans are essential for ensuring safety and efficiency during road work and emergency response situations. Lighted signage plays a crucial role in these plans. The signal mats 410 disclosed herein are highly visible and can be seen from a distance, even in poor weather conditions. The signal mats 410 may be equipped with LED lights that provide 360-degree visibility. The signal mats 410 can be placed on or near the surface of the road to mark the boundaries of the work zone or emergency area according to the traffic control plan, and can be used to indicate lane closures, detours, or areas where workers are present. By providing clear and bright warnings, the signal mats 410 can help alert drivers to slow down and proceed with caution. This reduces the risk of accidents and ensures the safety of both workers and motorists.

In emergency situations, the signal mats 410 can be quickly deployed to create a safe zone around the incident. The signal mats 410 help emergency responders by clearly marking the area and guiding traffic away from the scene. The lighted mats enhance safety by making work zones and emergency areas more visible to drivers. This reduces the likelihood of collisions and accidents. By clearly marking the boundaries of a work zone or emergency area, lighted mats help maintain traffic flow and reduce delays. The lighted mats can be used in various settings, including road construction, maintenance, and emergency response. They are durable and weather-resistant, making them suitable for different conditions.

In an example, the control circuit 435 may implement an intrusion alarm to alert workers in the work zone or emergency responders that an errant vehicle may have intruded into the work area so that the workers or emergency responders can get to safety out of the path of the vehicle. An example intrusion alarm includes a photo sensor (e.g., photocell or Infrared IR sensor). A photocell detects changes in light levels. When a vehicle drives over the mat, it momentarily blocks light or causes a shadow, triggering the sensor. An Infrared (IR) proximity sensor can detect solid objects (such as tires or vehicles) by emitting and detecting reflected IR light. A microcontroller processes the signal from the photo sensor and activates the alarm. The alarm (e.g., audio and/or visual alert(s)) are connected to an output pin of the microcontroller to trigger the alarm. If the alarm requires a higher voltage (e.g., 12V) than the microcontroller's output pin can provide, a relay module can switch on the alarm. Alerts can also be sent to the workers' mobile devices in addition to the audible alarm.

In an example, the intrusion alarm operates as follows. When a vehicle drives over the mat, the photo sensor (or IR sensor) detects the vehicle. The sensor sends a signal to the microcontroller indicating a change in state (e.g., detecting something above the mat). The microcontroller reads the sensor's signal and determines whether to trigger the alarm. If the sensor detects a vehicle, the microcontroller activates the buzzer. The microcontroller sends a signal to the audio and/or visual alert output to activate, producing a loud warning sound, similar to a fire alarm, to alert workers in the work zone. The microcontroller can also send a message to notify workers on their mobile devices.

As noted above, the lighted traffic control mats can also be provided for pedestrian use, helping meet compliance with The Americans with Disabilities Act (ADA), and eliminating tripping hazards. The signal mat 410 is designed to meet the latest ADA compliance standards, making it safe and accessible for all pedestrians, including those with disabilities. The signal mat 410 is engineered to minimize tripping hazards, ensuring a smooth and secure surface. This can be helpful for maintaining safety in public areas, especially where pedestrian traffic is high.

The signal mat 410 may feature wireless capabilities for remote control by users, offering ease of management. An intrusion alarm can be integrated, using sensors and a microcontroller to detect unauthorized access and alert users locally and remotely. The signal mat 410 includes flashing and steady burn lights to enhance visibility, similar to existing warning lights. The control setup involves field devices, a microcontroller with wireless communications capabilities, mobile app integration, and security measures, such as device pairing and encryption. For the alarm system, components include photo sensors, a microcontroller, a loud buzzer or other audible warning, and optional Wi-Fi or other wireless communications modules for remote alerts. The system can be powered by batteries or solar panels, ensuring its functionality in various locations.

Wireless communications enables field operators to manage and adjust the settings of the signal mat 410, such as lighting patterns and alarm activation, without needing physical proximity.

The signal mat 410 is equipped with LED lights that can flash and/or maintain a steady burn. This feature enhances visibility and can be customized based on the specific requirements of the situation. For example, flashing lights can be used to draw immediate attention in high-risk areas, while a steady burn can indicate ongoing caution. The control over these lighting patterns is managed through the wireless capabilities of the signal mat 410.

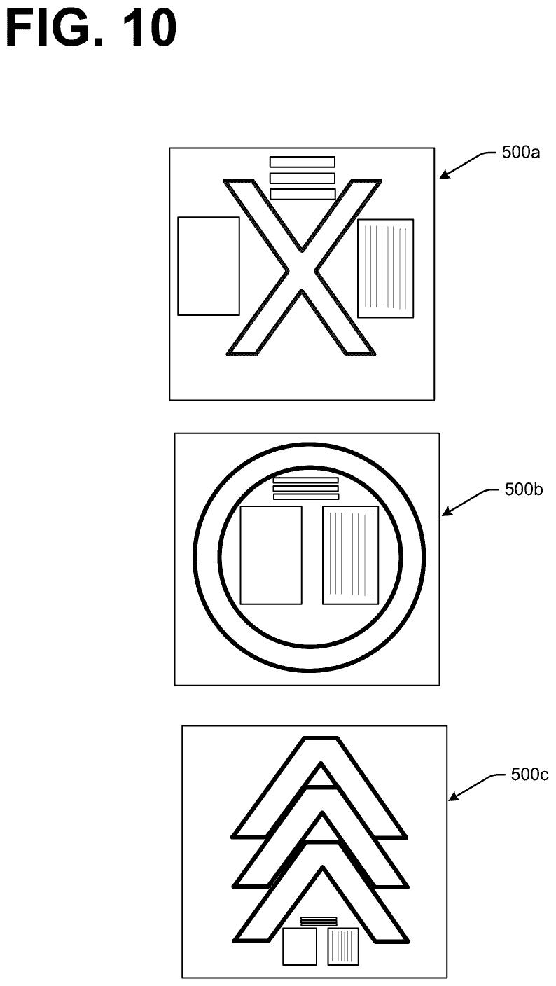

FIG. 10 are top views of example traffic control devices 500a, 500b, and 500c, which may be implemented in a system of traffic control devices. Each of the traffic control devices 500a, 500b, and 500c is preconfigured with a pattern, including an X (device 500a), an O (device 500b), and arrows (device 500c) which may be sequenced to show movement. FIG. 11 shows another example traffic control device 500d with a lighting panel which may be configured to output different lighting patterns on the same signal mat in a system of traffic control devices. The traffic control device 500d is shown with different patterns activated in the same lighting panel, including an X (pattern 510a), an O (device 510b), and arrows (device 510c). Again, the arrows may be sequenced to indicate movement.

Each signal mat of the example traffic control devices 500a, 500b, 500c, and 500d is made of heavy-duty rubber, ensuring it can withstand various weather conditions and the wear and tear of being on or near busy roads. The signal mat is about 3 inches tall, which helps to be noticeable to travelers. The dimensions of the signal mat 410 (about 3 feet by 3 feet) makes it large enough to display clear, visible signals without being cumbersome or obstructive.

The control circuit in the signal mat is equipped with a communications device that can receive signals from a range of remote devices. This can include sensor devices that detect traffic conditions, computing devices, and mobile device applications. This flexibility allows the signal mat to adapt to real-time changes in traffic conditions based on the signals received.

The lighting circuit in the signal mat can produce various light patterns, including blinking and solid lights, to alert travelers effectively. The lights can coordinate with other signal mats in the system to create a unified signal pattern that enhances visibility and understanding. The lights can also display different colors-red for stop, green for go, and yellow for caution-making the signals intuitive and easy to follow.

The traffic control plan can be generated using artificial intelligence (AI) and machine learning algorithms. As discussed above, these technologies can analyze traffic data and predict optimal traffic flow patterns. This means the system can dynamically adjust to changing traffic conditions, reducing congestion and improving safety by providing timely and accurate traffic signals.

The control circuit allows for detailed adjustments to the lighting circuit. This includes turning the lights on or off, changing between blinking and solid outputs, and adjusting the color and display patterns of the lights. These adjustments can be made remotely, ensuring that the system can respond quickly to changes in traffic conditions. The ability to switch between colors, such as red, green, and yellow, provides clear, universally understood signals to travelers.

As already discussed above, the control circuit of the signal mat can receive control signals from various remote devices, such as sensors, computing devices, or mobile applications, and coordinate lighting of a plurality of signal mats, to adapt to the traffic control plan. The lights on each signal mat can output coordinated light patterns, for example, with options to blink or stay solid, and can display different colors (red, green, warning yellow). The control circuit allows for remote adjustments to the lighting circuit on the signal mat 410, including activating/deactivating lights and changing light patterns and colors. The traffic control plan can be generated and even modified in real-time, using AI and machine learning to optimize traffic flow. This innovative system offers a flexible and intelligent solution to traffic management, enhancing safety and efficiency on roads and pathways.

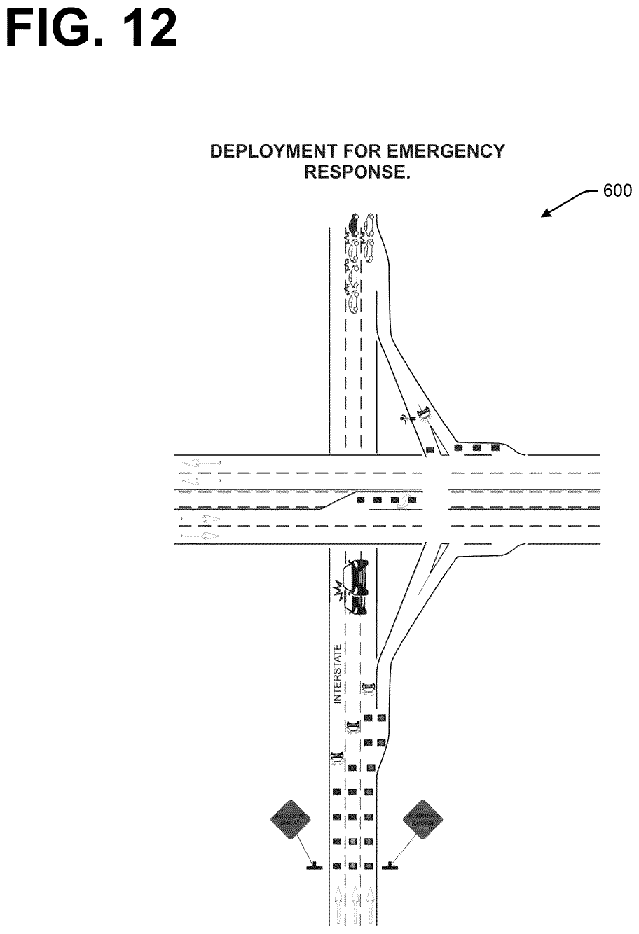

FIG. 12 illustrates an example deployment of traffic control devices configured for an emergency response situation 600. This example demonstrates how the traffic control system can be effectively used in emergency situations to manage traffic and enhance the safety of both responders and the public. By providing clear, coordinated light signals and allowing for real-time adjustments, the system helps to ensure a safe and efficient response to roadside accidents.

In an example, emergency responders arrive at the scene of a traffic accident. They quickly deploy several signal mats around the accident site, placing them at strategic points to manage approaching and diverting traffic. The control circuits in the signal mats are activated and configured to communicate with each other and with remote control devices held by the emergency responders. The mats are programmed with an initial traffic control plan to manage the immediate situation. Sensors on the signal mats detect approaching vehicles. The mats near the accident site display a solid red light to stop traffic, preventing vehicles from entering the dangerous area.

In an example of dynamic light coordination, signal mats placed further away from the accident start displaying yellow blinking lights to alert drivers to slow down and prepare to stop. These mats help manage the flow of traffic and reduce the risk of additional accidents. To help ensure the safety of emergency responders and accident victims, signal mats within the immediate vicinity of the accident display red or yellow lights, indicating restricted or cautionary zones. This helps create a safe workspace for responders to conduct their operations without interference from moving traffic. Emergency responders can use remote devices, such as mobile applications, to adjust the light patterns on the mats as the situation evolves. If additional emergency vehicles need to arrive or depart, the mats can be reconfigured to provide clear and safe pathways.

As the accident scene is cleared, the system helps in gradually resuming normal traffic flow. Signal mats at critical points might display green lights, guiding vehicles safely past the cleared accident site and back onto the main road. If there are ongoing hazards, such as debris on the road, the mats can continue to display appropriate warnings, ensuring that drivers remain alert and cautious.

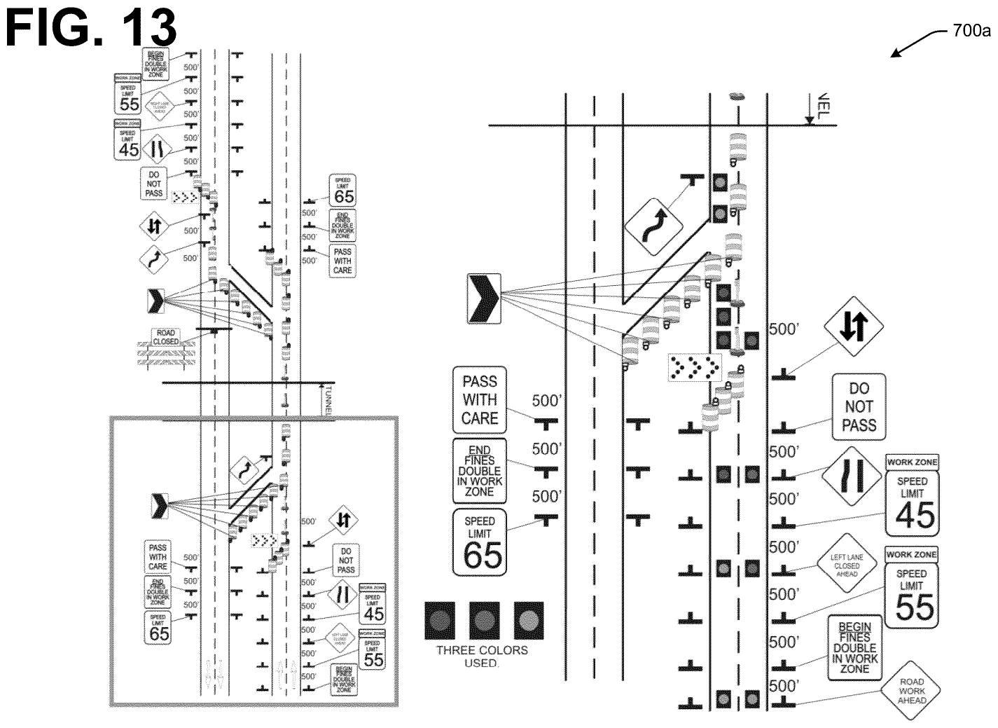

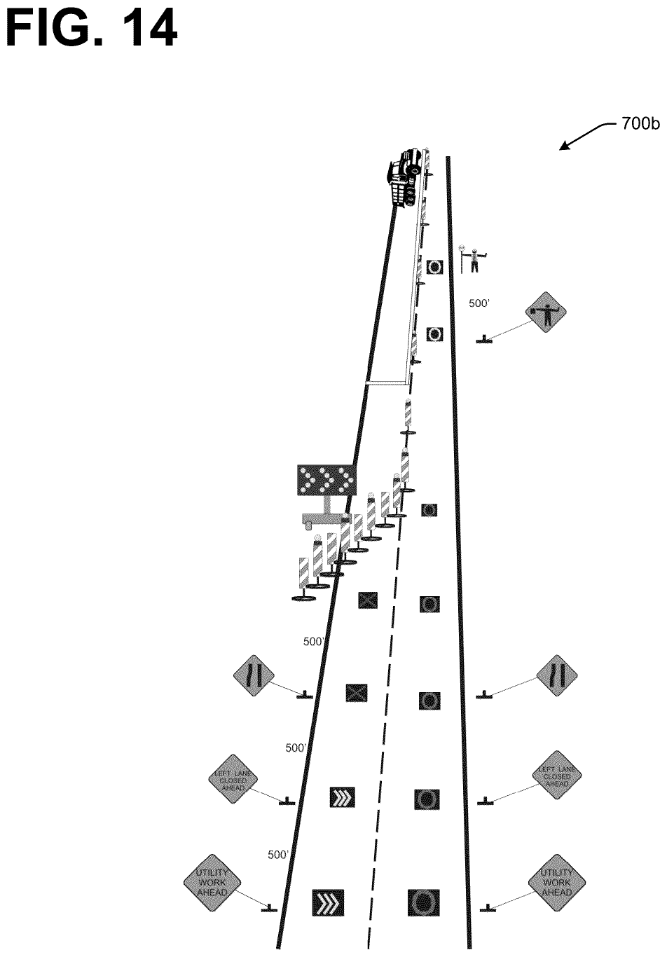

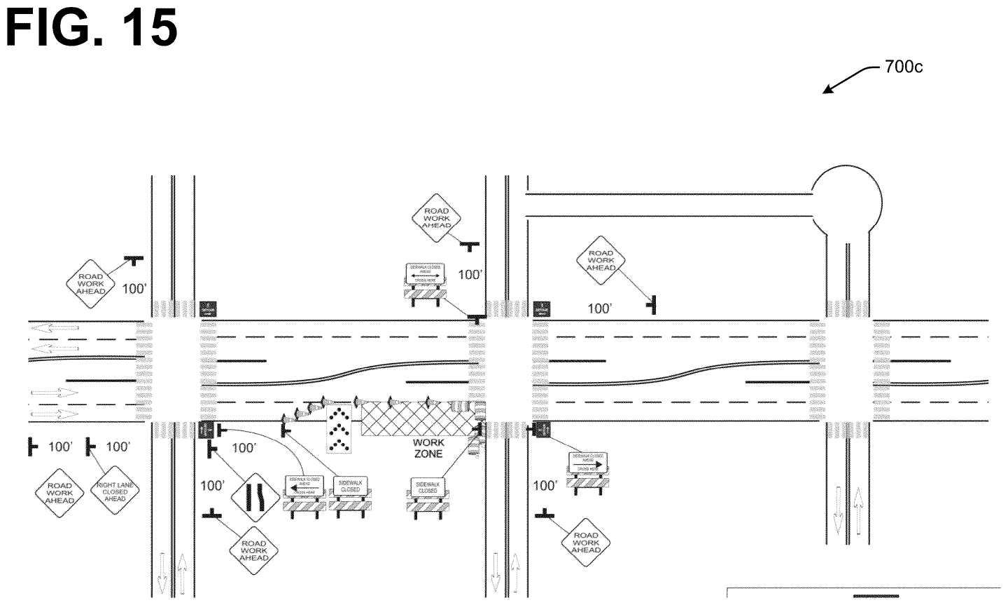

FIGS. 13-15 illustrate examples of deployment of traffic control devices configured for various types of work zones 700a-c. These examples illustrate how the traffic control system can be used to manage traffic flow and enhance worker safety at a road work site. By dynamically adjusting light patterns and coordinating with remote devices, the system ensures that both drivers and workers remain safe and that traffic moves smoothly through the construction zone.

The traffic control system includes multiple signal mats designed for placement on or near roads and pathways. Each mat is equipped with a lighting circuit featuring multiple lights and a control circuit. The control circuit contains a communications device that allows for remote interaction with other signal mats and executes a coordinating program to manage the lighting circuit. This system aims to alert travelers about the traffic control plan.

When implemented for road work traffic management, signal mats can be placed at various points around the road work area. As shown in FIGS. 13-15, the signal mats are located at the start and end of the construction zone, as well as at key points where traffic needs to be controlled, such as lane merges and pedestrian crossings.

During initialization, the control circuits in the signal mats are activated, and the mats are programmed with the traffic control plan, which can be generated using AI and machine learning to optimize traffic flow and safety.

After deployment and during operation, sensors on the signal mats detect the presence and flow of vehicles approaching and passing through the road work zone. These sensors send real-time data to the control circuits.

In an example, the system may implement dynamic light coordination. Based on the traffic data, the mats display coordinated light patterns to manage vehicle flow. For example, mats at the entrance to the work zone might show a solid red light to stop traffic while workers move equipment or complete a task. Once it's safe to proceed, the mats can switch to a green light, allowing vehicles to move through the area in an orderly fashion.

In an example, the system may generate worker safety alerts. To help ensure worker safety, mats within the work zone can display blinking yellow lights, warning drivers to slow down and be cautious. If workers need to cross the road, the mats can coordinate to show red lights, stopping traffic temporarily. If a vehicle leaves the route, workers can be alerted in advance so that they can take action, such as getting to safety, to avoid being in the path of the stray vehicle and potentially being injured.

In an example, remote adjustments can be made by traffic control supervisors. Traffic control supervisors can use remote devices, such as mobile applications, to adjust the light patterns as needed. For instance, if there's an unexpected increase in traffic volume, the system can extend stoppages or pause durations to reduce or even prevent traffic backups and congestion.

The control circuits can also receive control signals from remote devices, such as sensor devices that detect hazardous conditions (e.g., a sudden rain), increasing traffic, emergency response vehicles (e.g., indicating a traffic accident). These signals can be implemented to trigger the signal mats to adjust their light patterns accordingly, enhancing safety.

In an example, traffic flow transitions can be implemented according to the time of day. For example, as road work concludes for the day, the system gradually transitions traffic back to normal flow. Signal mats display light patterns that guide vehicles out of the construction zone safely and efficiently.

If the work zone remains partially active during nighttime, the mats can display specific light patterns, such as blinking red or yellow, to alert drivers of the ongoing work and the need for caution.

Still other examples are contemplated as being within the scope of the disclosure herein. By way of further non-limiting illustration, the traffic control system may be implemented for school zone traffic management. This traffic control system is used to manage traffic flow at a busy intersection near a school during drop-off and pick-up times. It will be readily understood by those having ordinary skill in the art after becoming familiar with the teachings herein, that similar strategies may be implemented for special events (e.g., concerts, sporting events, etc.).

In the case of a school zone, multiple signal mats are placed strategically on the roads leading to and around the school. Each mat is connected to a central control unit via remote communication devices. As the school day begins, sensors detect an increase in vehicle and pedestrian traffic. These sensors send signals to the control circuits of the signal mats. Based on the received signals, the mats activate their lighting circuits to display coordinated light patterns. For example, mats near crosswalks might blink yellow to alert drivers to slow down and prepare to stop for pedestrians. Mats at the intersection could show green for vehicles moving towards the drop-off zone and red for other directions to prevent congestion.

The control circuits use AI and machine learning algorithms to analyze traffic patterns in real-time. If traffic begins to back up, the system can dynamically adjust the light patterns, such as extending the green light duration for the drop-off lane or introducing a red light to allow crossing guards to safely guide students across the road.

The traffic plan can also be optimized. By way of example, the system can generate and update the traffic control plan continuously based on the live data. This includes adjusting light patterns, blinking rates, and colors to ensure optimal traffic flow and safety.

Before the peak pick-up time, the system prepares by analyzing historical data (e.g., day of week, time of day, seasonal, holidays, etc.) to anticipate high traffic volumes. The signal mats start by displaying a pattern that slowly transitions from yellow to red near crosswalks, alerting drivers well in advance.

The system may implement dynamic light coordination. For example, as parents arrive, the system again uses sensors to monitor traffic. If a line of cars forms, the mats can coordinate to create a “green wave,” where cars are given sequential green signals to keep moving efficiently through the drop-off area.

The system may implement responsive adjustments. For example, if an unexpected surge in traffic occurs, the system responds by modifying light patterns to balance vehicle flow with pedestrian safety. For instance, if there's a sudden influx of pedestrians, the lights at crosswalks might switch to a solid red, giving pedestrians ample time to cross safely.

Once the pick-up rush subsides, the system gradually returns to normal operation, with standard light patterns resuming to maintain regular traffic flow. This example highlights the flexibility and intelligence of the traffic control system, ensuring safety and efficiency during high-traffic periods in sensitive areas like school zones.

It is noted that the examples shown and described are provided for purposes of illustration and are not intended to be limiting. Still other examples are also contemplated.

The invention claimed is:

1. A traffic control system, comprising:
a plurality of separate signal mats for placement on a surface on or near a road or pathway;
a lighting circuit having a plurality of lights mounted to each of the signal mats;
a control circuit mounted to each of the signal mats;
a communications device of the control circuit configured for remote communications with the communications device of at least one other of the signal mats; and
a programming module of the control circuit, the programming module executing a coordinating program to operate the lighting circuit based at least in part on the remote communications with the at least one other signal mat to alert travelers on or approaching the road or pathway to a traffic control plan.

2. The lighted traffic control device of claim 1, wherein the mat is a heavy rubber mat.

3. The lighted traffic control device of claim 1, wherein the mat is about 3 inches tall and about 3 feet wide by 3 feet long.

4. The lighted traffic control device of claim 1, further comprising at least one mat attachment for each of the separate mats to attach the separate mats on or near the surface of the road or pathway.

5. The lighted traffic control device of claim 1, wherein the communications device of the control circuit receives a control signal from a remote device.

6. The lighted traffic control device of claim 5, wherein the remote device is a sensor device.

7. The lighted traffic control device of claim 5, wherein the remote device is a computing device.

8. The lighted traffic control device of claim 7, wherein the remote device is a program application executing on a mobile device.

9. The lighted traffic control device of claim 5, wherein the control signal corresponds to the traffic control plan.

10. The lighted traffic control device of claim 9, wherein the control circuit communicates with the lighting circuit to activate/deactivate the lights based at least in part on the traffic control plan specified by the control signal.

11. The lighted traffic control device of claim 9, wherein the control signal specifies lighting output for the control circuit to communicate to the lighting circuit.

12. The lighted traffic control device of claim 1, wherein the traffic control plan is generated at least in part based on artificial intelligence (AI).

13. The lighted traffic control device of claim 1, wherein the control signal for the traffic control plan is generated at least in part based on a machine learning program.

14. The lighted traffic control device of claim 1, wherein lights of the lighting circuit on one of the signal mats output a light pattern coordinated with the lighting circuit of at least one other of the signal mats.

15. The lighted traffic control device of claim 1, wherein the lights of the lighting circuit are provided as a panel to output a light pattern selected from a plurality of different light patterns.

16. The lighted traffic control device of claim 1, wherein the control circuit receives a remote control signal.

17. The lighted traffic control device of claim 1, wherein the control circuit receives a remote control signal to configure output of the lighting circuit.

18. The lighted traffic control device of claim 1, wherein the control circuit is operable to activate/deactivate lights of the lighting circuit and to control blinking/solid output, color output, and display pattern output of the lights of the lighting circuit.

19. The lighted traffic control device of claim 18, wherein output color of the lights is at least one of red, green, and warning yellow.

20. The lighted traffic control device of claim 18, wherein output color of the lights is controllable to switch between the different colors.
